(19) United States
(12) Patent Application Publication
(10) Pub. No.: US 2023/0057077 A1
(43) Pub. Date: Feb. 23, 2023

(54) METHOD AND APPARATUS FOR RESOLVING V2X RESOURCE COLLISIONS

(71) Applicant: Autotalks Ltd., Kfar Netter (IL)

(72) Inventors: Ohad Ashery Bonaventura, Tel Aviv (IL); Yossi Shaul, Givatayim (IL)

(21) Appl. No.: 17/404,456

(22) Filed: Aug. 17, 2021

(51) Int. Cl. H04W 74/08; H04W 4/40

(52) U.S. Cl. CPC H04W 74/0808; H04W 4/40

(57) ABSTRACT

Apparatus and methods including by a first and second vehicle-to-everything (V2X) transceiver operating in a V2X environment, transmitting using a first resource; by a third V2X transceiver, detecting of a collision on the first resource caused by the transmissions of the first and second V2X transceivers; by the third V2X transceiver, transmitting of a collision advertisement (CA); and by one of the first and second V2X transceivers, reselecting a resource based on the CA.

### FIELD

Embodiments disclosed herein relate in general to vehicle-to-everything (V2X) communications, and in particular to systems and methods for resolving collisions of transmitted data.

### BACKGROUND

C-V2X (cellular V2X) makes use of cellular communication technology for V2X communications. The C-V2X communication channel is divided into subframes (SF) in the time domain, and subchannels (SC) in the frequency domain. Each pair of {SF,SC} is considered a ‘resource’ (also referred to herein as “resources” or “transmission resources”). V2X devices include transmitters that periodically send packets on one or more SC within a single SF (according to the packet size).

In a “mode 4” allocation of a C-V2X network, which is typically the only used mode, there is no central entity that allocates transmission resources for each transmitter. Instead, V2X devices are required to “sense” the channel, by listening (receiving) and aggregating the history of transmissions by other nearby devices, per each resource, and by then inferring the probability of each resource being occupied or free for future use. Once this sensing has been performed, the transmitter may randomly select resources from a pool of the most likely free resources. The transmitter may then transmit on the selected resources for a random period (up to several seconds), after which the transmitter may select an alternative resource (a procedure referred to as ‘reselection’).

Each V2X transmission includes a control frame (herein referred to as physical sidelink control channel or PSCCH) and a data frame (herein referred to as physical sidelink shared channel or PSSCH). The control PSCCH holds information regarding the data PSSCH transmission parameters, such as the SC used, encoding, priority, and so forth. The PSCCH transmission parameters (power, encoding) are such that the PSCCH is easily decoded, even in unfavorable channel conditions.

A transmission resource collision (or as used herein simply “collision”) occurs when two (or more) V2X transmitters simultaneously transmit using the same (fully or partially overlapping) set of resources. In such a case, some of the surrounding (receiving) vehicles may be able to decode one of the transmissions, but none are able to decode all of the transmissions. This receiving failure caused by the collision may continue for several seconds, until at least one of the transmitters performs reselection.

A collision may typically be caused by one of the following scenarios: a random collision where multiple transmitters randomly selected the same resource/s; or a hidden node where, at the time of reselection, the transmitters were out of range (each received the other's signal with very low power), thus each not sensing the other and assuming the resource was free. The chances of collisions occurring are significant, such as shown by Jeon et al (Jeon, Yongseok, Seungho Kuk, and Hyogon Kim. “Reducing message collisions in sensing-based semi-persistent scheduling (SPS) by using reselection lookaheads in cellular V2X.” Sensors 18.12 (2018): 4388). For example, with a churn rate (vehicles entering/exiting communication range) of 10%/s, and a channel busy ratio (CBR) of 80%, the collision probability is slightly below 10%, and for a CBR of 90%, the collision probability is close to 14%. Without churn, at 70% CBR, the collision probability is 5.5%, and for a 90% CBR the collision probability is 12.8%.

In the above process, the time from the collision until a resource reselection is completed (referred to herein as “time to collision resolution” or TTCR) is typically more than 500 ms and may even be several seconds. It should be appreciated that the resultant missed transmissions and delay in retransmitting may have serious consequences related to vehicle safety.

There is therefore a need for, and it would be advantageous to have systems and methods for quickly resolving such collisions and for providing a method for informing the transmitting system of the collision.

### SUMMARY

Embodiments disclosed herein relate to apparatus and methods for quickly resolving collisions caused by use of the same resources. In some embodiments, where at least a first and second V2X transceiver transmit using the same first resource (whether a full or partial/overlap of resource usage) causing a collision, a third V2X transceiver may detect the collision on the first resource. The third V2X transceiver may then broadcast a collision advertisement regarding the collision. Upon receiving the collision advertisement, the first and second V2X transceivers may perform reselection such that the first V2X transceiver switches to transmitting on a second resource and the second V2X transceiver switches to transmitting on a third resource such that the collision no longer occurs.

In the disclosed process, the TTCR may be less than 0.1 seconds. It should be appreciated that the resultant saving of time in the TTCR will significantly improve vehicle safety since the TTCR may be several seconds less than in implementations as described in the introduction above. In a non-limiting example where a vehicle needs to brake for an emergency, assuming a vehicle speed of 72 kph (20 m/s), each 100 ms translates to 2 m covered, so earlier detection by, for example, 500 ms may translate to braking 10 m earlier, which is one third of the typical braking distance at that speed. Further, the disclosed process also provides a solution for collisions caused by hidden nodes, where the receiving transceiver notifies both transmitting nodes that did not detect one another.

In some embodiments, the third V2X transceiver may apply a collision advertisement policy to determine whether to broadcast a collision advertisement. In some embodiments, the first and second V2X receivers may apply a reselection policy, upon receiving the collision advertisement, to determine whether to perform reselection.

In some exemplary embodiments, a method includes: by a first vehicle-to-everything (V2X) transceiver and a second V2X transceiver operating in a V2X environment, transmitting using a first resource; by a third V2X transceiver, detecting of a collision on the first resource caused by the transmissions of the first and second V2X transceivers; by the third V2X transceiver, transmitting of a collision advertisement (CA); and by one of the first and second V2X transceivers, reselecting a resource based on the CA.

In some embodiments, the collision detection may be performed by one or more of: decoding a physical sidelink control channel (PSCCH) on a subchannel (SC) that is known to carry a physical sidelink shared channel (PSSCH), attempting and failing to decode a PSSCH on an SC that is known to carry a PSCCH, and/or failing to decode both a PSCCH and a PSSCH on a SC with a high received signal strength indicator (RSSI).

In some embodiments, the CA is transmitted as part of a V2X transmission from the third V2X transceiver. In some embodiments, the CA is inserted into the padding of a V2X packet. In some embodiments, the CA is transmitted in a dedicated packet. In some embodiments, the CA comprises CA parameters including one or more of: a collision confidence level (CCL), an indication of the resource on which a collision was detected, an RSSI measured on the resource, and/or a priority of a decoded PSCCH.

In some embodiments, the CA is identified by at least one of the first and second V2X transceivers based on an identifier prefix in the CA parameters. In some embodiments, the method further includes, determining by at least one of the first and second V2X transceivers that the indicated resource is the same as the first resource used by at least one of the first and second V2X transceivers.

In some embodiments, the resource reselection is based on one or more of: the received CA parameters, a transmission process that used the resource, an allocation type used, a Channel Busy Ratio (CBR), and/or a priority of transmission. In some embodiments, a time to collision resolution (TTCR) is between 50 ms and 200 ms.

In some exemplary embodiments, a system includes: a first vehicle-to-everything (V2X) transceiver operating in a V2X environment configured for detecting a collision caused by transmissions from at least a second and third V2X transceiver using the same first resource, wherein the first V2X transceiver is further configured for transmitting of a collision advertisement (CA) describing the detected collision. In some embodiments, the at least second and third V2X transceivers are configured for decoding the CA and for determining whether to perform reselection of a resource based on the CA.

In some embodiments, the collision detection may be performed by one or more of: decoding a physical sidelink control channel (PSCCH) on a subchannel (SC) that is known to carry a physical sidelink shared channel (PSSCH), attempting and failing to decode PSSCH on an SC that is known to carry PSCCH, failing to decode both PSCCH and PSSCH on a SC with a high received signal strength indicator (RSSI).

In some embodiments, the CA is transmitted as part of a V2X transmission from the first V2X transceiver. In some embodiments, the CA is inserted into the padding of a V2X packet. In some embodiments, the CA is transmitted in a dedicated packet. In some embodiments, the CA includes CA parameters including one or more of: a collision confidence level (CCL), an indication of the resource on which a collision was detected, an RSSI measured on the resource, and/or a priority of a decoded PSCCH.

In some embodiments, the CA is identified by the at least second and third V2X transceivers based on an identifier prefix in the CA parameters. In some embodiments, the at least second and third V2X transceivers are configured for determining that the indicated resource is the same as the first resource used by the at least second and third V2X transceivers.

In some embodiments, the resource reselection is based on one or more of: the received CA parameters, a transmission process that used the resource, an allocation type used, a Channel Busy Ratio (CBR), and/or a priority of transmission. In some embodiments, the system is configured such that a time to collision resolution (TTCR) is between 50 ms and 200 ms.

This Summary is provided to introduce a selection of concepts in a simplified form that are further described in the Detailed Description below. It may be understood that this Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings, and from the claims.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein and should not be considered limiting in any way. Like elements in different drawings may be indicated by like numerals.

FIGS. 1A and 1B show respectively, a V2X network and a V2X transceiver according to some embodiments;

FIG. 2 illustrates in a flowchart of a process for resolving collisions between two or more V2X transceivers according to some embodiments;

FIG. 3A illustrates in a flowchart of a process for resolving collisions between two or more V2X transceivers according to some embodiments;

FIG. 3B shows a timeline of a process for resolving collisions between two or more V2X transceivers according to some embodiments;

FIG. 4 shows CA data inserted into a padding of a V2X packet according to some embodiments;

FIG. 5 shows a process for determining that a collision has occurred according to some embodiments.

### DETAILED DESCRIPTION

In various embodiments, there are disclosed apparatus and methods that may sense collisions between two or more V2X transmitters and mitigate the collisions quickly, such that proper V2X communication is restored.

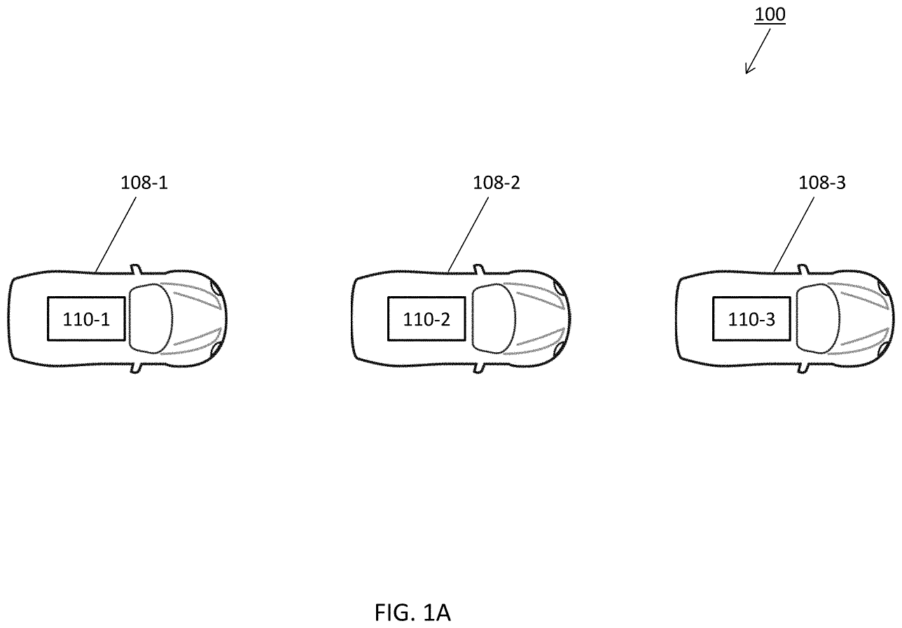

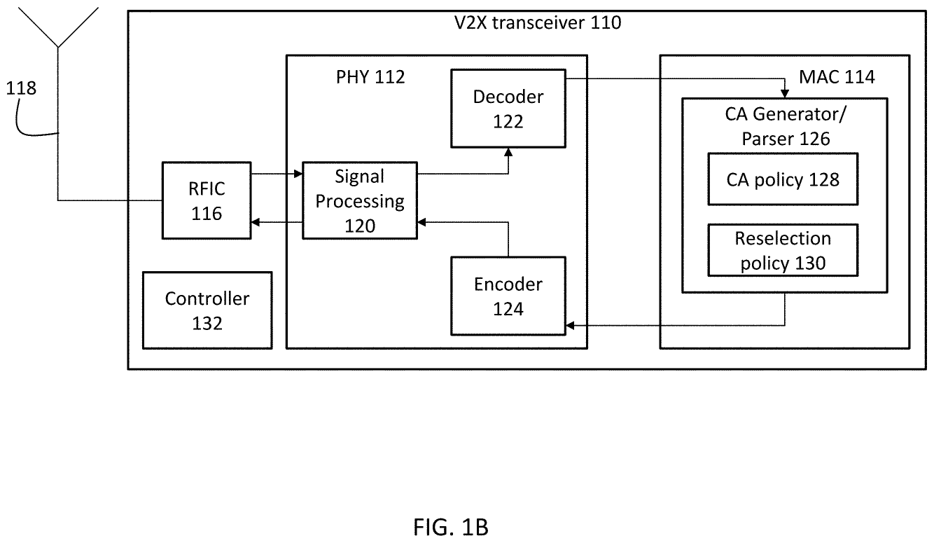

FIGS. 1A and 1B show respectively, a V2X network and a V2X transceiver according to some embodiments. As shown in FIG. 1A, in a non-limiting example, a V2X network 100 includes three vehicles 108-1, 108-2, and 108-3. It should be appreciated that the number of vehicles shown is exemplary and that V2X network 100 may include more or less vehicles. Each vehicle 108 includes a V2X transceiver 110 (herein designated 110-1, 110-2 and 110-3).

As shown in FIG. 1B, each V2X transceiver 110 may include physical layer components (herein designated “PHY 112”), link layer components (herein designated “MAC 114”), a radio frequency integrated circuit (RFIC) 116 providing RF transmitter/receiver functionality, and one or more antennas 118. PHY 112 may include a signal processing module 120, a decoder 122, and an encoder 124. MAC 114 may include a collision advertisement (CA) generator/decoder 126.

In some embodiments, V2X transceiver 110 may include a controller 132. Controller 132 may manage the operation of the components of transceiver 110 and may direct the flow of data between the components of transceiver 110. Where transceiver 110 may be said herein to provide specific functionality or perform actions, it should be understood that the functionality or actions are performed by controller 132 that may operate other components of transceiver 110. In some embodiments, the functionality of controller 132 is distributed between other components of transceiver 110.

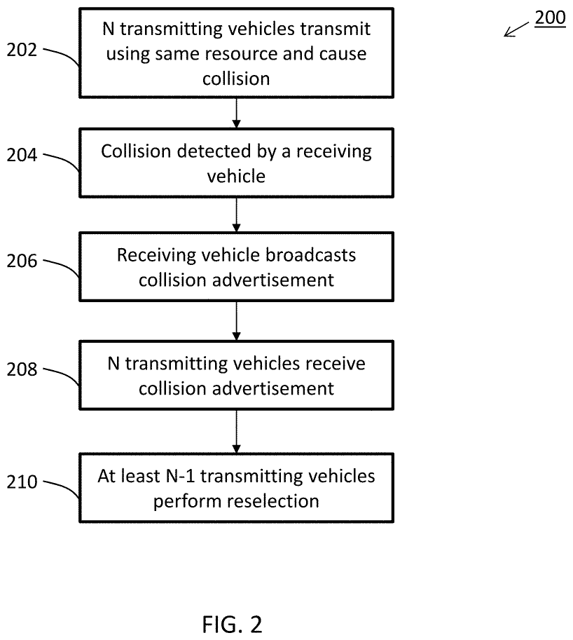

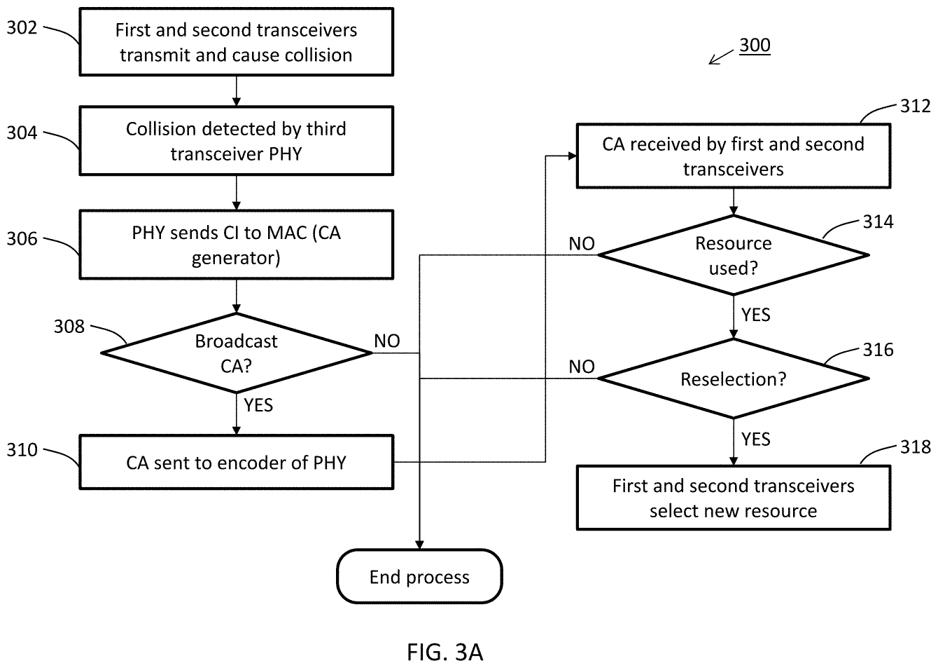

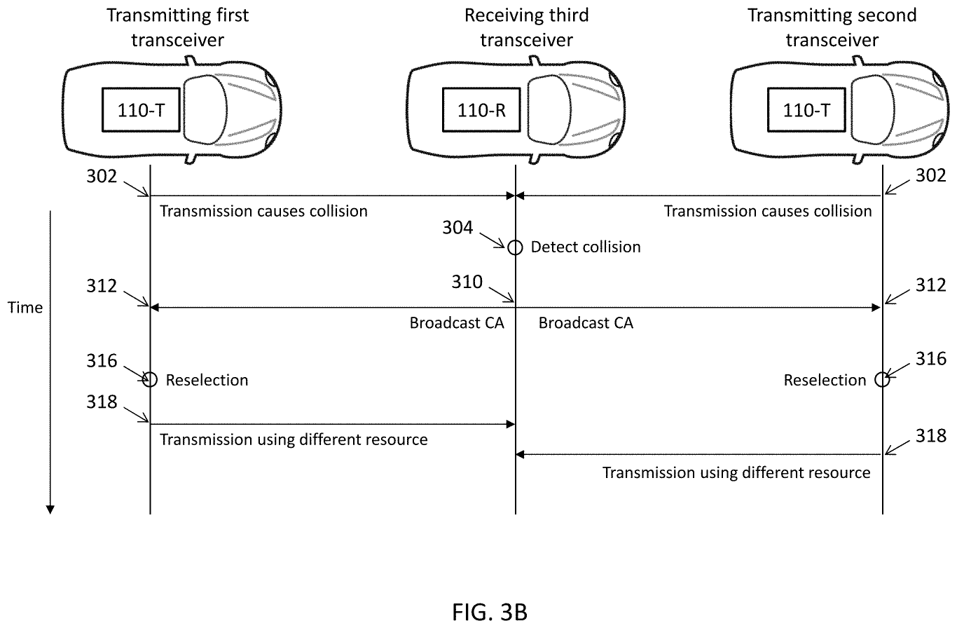

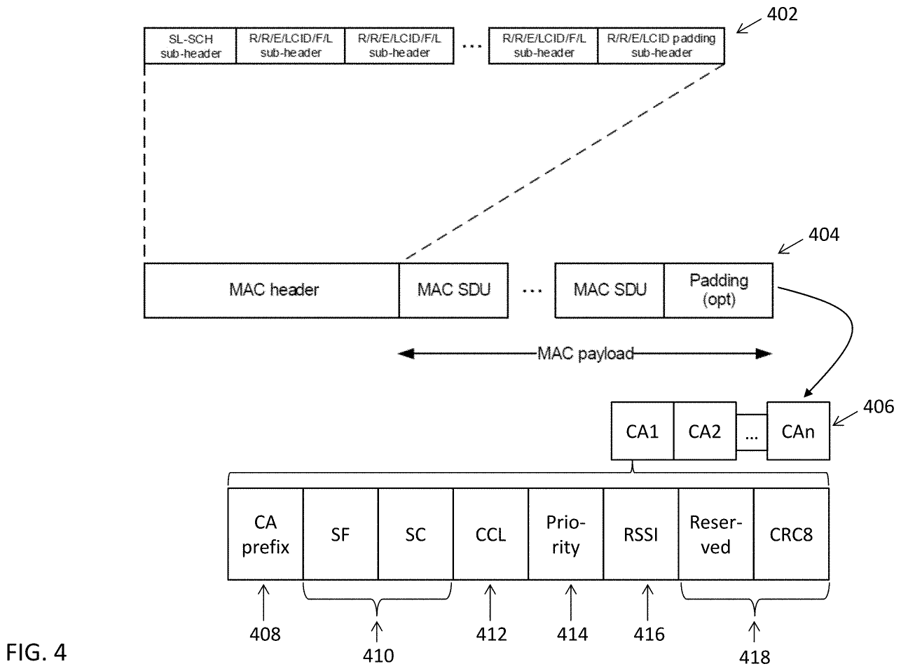

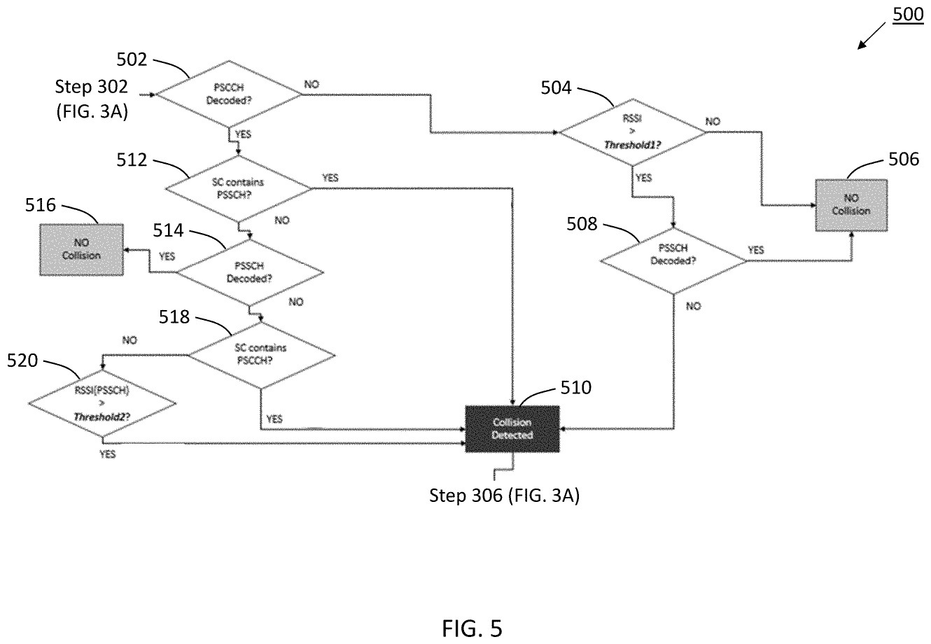

FIG. 2 illustrates in a flowchart of a process 200 for resolving collisions between two or more V2X transceivers according to some embodiments. Process 200 is described further below in more detail with reference to FIG. 3. In step 202, N (an integer value greater than 2) transmitting vehicles may attempt to transmit on a first resource, resulting in a collision. In a non-limiting example, vehicles 108-1 and 108-3 may transmit simultaneously on a first resource using transceivers 110-1 and 110-3 respectively resulting in a collision. In step 204, a receiving vehicle may detect the collision on the first resource. In the non-limiting example, vehicle 108-2 using transceiver 110-2 may detect the collision. In step 206, the receiving vehicle may broadcast an advertisement regarding the collision on the first resource. In the non-limiting example, vehicle 108-2 using transceiver 110-2 broadcasts the collision advertisement.

In step 208, the transmitting vehicles (108-1 and 108-3) may receive (using transceivers 110-1 and 110-3 respectively) the collision advertisement from receiving vehicle (108-2) and, in step 210, at least N−1 of the transmitting vehicles may perform reselection. For example, where both perform reselection, vehicle 108-1 switches to transmitting (using transceiver 110-1) on a second resource and vehicle 108-3 switches to transmitting (using transceiver 110-3) on a third resource such that the collision no longer occurs. Although the terms “transmitting vehicle” and “receiving vehicle” are used herein to differentiate between vehicle causing a transmission collision ad vehicles receiving and indicating the collision, it should be appreciated that transmitting vehicles also receive transmissions and receiving vehicles also transmit.

In some implementations, the TTCR in process 200 may be between 50 ms and 100 ms. In some implementations, the TTCR in process 200 may be between 50 ms and 200 ms.

FIG. 3A illustrates in a flowchart and FIG. 3B a time flow of a process 300 for resolving collisions between two or more V2X transceivers according to some embodiments. Process 300 may take place, for example, in network 100 using the elements of network 100 as described above with reference to FIGS. 1A and 1B. The description of process 300 describes first and second transceivers (each within a vehicle) and a third transceiver (also within a vehicle) but it should be appreciated that the number of transmitting and/or receiving transceivers depicted should not be considered limiting. Although referred to herein as “transmitting transceivers 110” It should be appreciated that the transmitting transceivers 110 also receive V2X transmissions and the term is used to differentiate these transceivers from “receiving transceivers 100” where the “receiving transceivers also perform V2X transmissions.

In step 302, N transmitting first and second transceivers 110 transmit on a first resource, resulting in a collision. The resources used by the transmitting first and second transceivers 110 may be fully or partially overlapping.

In step 304, at least one receiving third transceiver 110 may detect the collision on the first resource. In some embodiments, the collision detection takes place in decoder 122 of the receiving third transceiver 110. The collision detection process is more fully described below with reference to FIG. 5. In some embodiments, the collision detection may be performed by one or more of:
Decoding PSCCH on an SC that is known to carry PSSCH
Attempting and failing to decode PSSCH on an SC that is known to carry PSCCH; and/or
Failing to decode both PSCCH and PSSCH on a SC with high power, for example where the received signal strength indicator (RSSI) is above a sensitivity threshold and should be decodable but cannot be decoded (due to the overlapping use of resources).

In some embodiments, decoder 122 of third transceiver 110 may determine that a collision is suspected herein referred to as a “suspected collision”) based on one or more of the collision detection mechanisms listed.

In step 306, having detected a collision or suspected collision, decoder 122 of third transceiver 110 in PHY 112 signals CA generator 126 in MAC 114 of the third transceiver 110. The signal sent to CA generator 126 is herein referred to as a collision indication (CI). In some embodiments, CI may include one or more of the following data elements:
The resource on which a collision was detected;
A collision confidence level (CCL) of the detection,
The RSSI measured on the resource,
If PSCCH of any packet (transmitted on the resources) was decoded, the priority (PPPP) of the packet.

In step 308, the receiving third transceiver 110 determines whether to broadcast an indication regarding the collision on the first resource. The indication may be generated by CA generator 126 of third transceiver 110 and is herein indicated as a collision advertisement (CA). In some embodiments, when a CI is received from PHY 112 of third transceiver 110, it enters a queue of detected CIs. In some embodiments, CA generator 126 of third transceiver 110 dequeues CIs one by one and applies a CA policy 128. In some embodiments, the CA policy 128 considers parameters included in the CI such as but not limited to RSSI, CCL, priority, and so forth, in order to determine whether a CA should be generated and transmitted. In some embodiments, CA generator 126 of third transceiver 110 may further listen for transmissions from other CA generators (from other receiving transceivers 110) regarding the same resource, and if such CAs are received, the CA generator 126 of third transceiver 110 may determine (according to CA policy 128) not to transmit its own CA, or alternatively to transmit a CA with a higher CCL than originally determined since the receiving third transceiver is aware that other transceivers have detected the same collision and the probability of a real collision has increased.

In step 310, CA generator 126 of third transceiver 110 determines that a CA should be broadcast. In some embodiments, the CA to be broadcast is sent to encoder 124 of PHY 112 of the receiving third transceiver 110. In some embodiments, a CA may be encoded into the padding section of a standard C-V2X packet (such as shown in FIG. 4) if the padding length is at least 48 bits. In some embodiments, additional CAs may be stored into the padding section in multiples of 48 bits. In some embodiments, the receiving transceiver 110 may transmit a dedicated CA packet. In some embodiments, the CA may be encoded in other sections of V2X packet payload or control.

In some embodiments, the receiving transceiver 110 may transmit a CA within another form of transmission. In some embodiments, the broadcast CA may include one or more of the data elements/parameters (408-420) as described with reference to FIG. 4.

In step 312, transmitting first and second transceivers 110 may receive the CA from the receiving third transceiver. In some embodiments, when a transmitting first or second transceiver 110 receives a packet, the CA parser 126 checks whether the packet contains a CA. In some embodiments, where a CA is stored in the padding of a V2X packet, the identifier prefix, inserted at the beginning of the padding, causes the CA parser to identify and then parse the following CA fields. In some embodiments, the parser calculates a CRC8 for the CA fields and if the CRC8 matches the CRC8 provided in the CA, the parser can be certain that a valid CA has been received and not incidental/random bits falsely identified as a CA.

If a CA is found, then, in step 314, CA parser 126 of MAC 114 of one or both of the transmitting first and second transceivers 110 extracts the resource ID from the CA and checks whether the transmitting (first or second) transceiver 110 is currently using the indicated resource. If the indicated resource is not currently in use by the transmitting transceiver 110, the CA is discarded and process 300 ends.

If the indicated resource is currently in use by the transmitting (first or second) transceiver 110, then in step 316, CA parser 126 of the transmitting transceiver 110 applies a reselection policy 130 to determine whether reselection should be triggered. In some embodiments, a reselection policy 130 may be based on one or more of:
All received CA parameters for the same resource;
Internal parameters, including but not limited to the specific transmission process which used the resource upon which the collision was detected, an allocation type (SPS or ad-hoc), a Channel Busy Ratio (CBR) that provides an indication of the general channel load, and/or the priority of transmission.

If reselection is triggered, then in step 318, at least one of the transmitting first or second transceivers 110 indicate the resource on which the collision was detected as ‘occupied’, and at least one of the transmitting first or second transceivers 110 switch to transmitting on an alternative resource such that collision no longer occurs. As shown in FIG. 3B, the transmitting first and second transceivers may transmit on the reselected alternative resource at different times. In some implementations, the TTCR in process 300 may be between 50 ms and 100 ms. In some implementations, the TTCR in process 300 may be between 50 ms and 200 ms.

In some embodiments, where a received packet contains multiple CAs, steps 314-318 are repeated for each received CA.

FIG. 4 shows CA data inserted into a padding of a V2X packet according to some embodiments. As shown, a MAC PDU frame structure 402 may include padding 402. In some embodiments, a CA 406 may be encoded into the padding 402 if the padding length is at least 48 bits. In some embodiments, additional CAs may be stored in the padding section in multiples of 48 bits. In some embodiments, the broadcast CA may include one or more of the following data elements:
An identifier prefix 408, inserted at the beginning of the padding;
Resource(s) 410 on which the collision was detected, optionally indicated as {SF, SC};
A CCL 412 indicating a confidence level of collision detection;
The priority 414 of any of the transmissions;
The RSSI 416 measured on the resource; and/or
Reserved and checksum data elements 418.
   As above, in some embodiments, the CA may alternatively be transmitted in a dedicated CA packet, or may be encoded in other sections of packet payload or control, or may be transmitted within another part of the V2X transmissions. These alternative methods for transmission of the CA may utilize one or more of the CA data elements (408-418) described above.

FIG. 5 illustrates in a flowchart of a process 500 for determining that a collision has occurred according to some embodiments. Process 500 may take place, for example, in network 100 using the elements of network 100 as described above with reference to FIGS. 1A and 1B and particularly takes place in a receiving transceiver 110. The steps below are therefore performed by a receiving transceiver 110 and/or optionally with controller 132. Process 500 takes place at step 304 of process 300 as described above. Process 500 takes into account that SCs may be scanned in an arbitrary order, and therefore, once a PSCCH is detected, its associated PSSCH may be decoded at a later time, and further, PSSCHs are not necessarily decoded in the order of detection of their associated PSCCH.

In step 502, receiving transceiver 110 may determine whether a received PSCCH may be decoded. If the PSCCH cannot be decoded, then in step 504 it is determined whether an RSSI is above a defined threshold. In step 506, if the RSSI is not above the threshold then it may be determined that no collision has taken place. In step 508, if the RSSI is above the threshold then it may be determined whether a PSSCH associated with a previously decoded PSCCH may be decoded. In step 506, if the PSSCH may be decoded then it may be determined that no collision has taken place. If the PSSCH may not be decoded then, in step 510, it may be determined that a collision has occurred, and the process continues as at step 306 of process 300. In such a determination the CCL will be proportional to the RSSI such that the higher the RSSI, the higher the CCL.

If, in step 502, the PSCCH is decoded, then, in step 512 it is determined whether any PSSCH associated with a previously decoded PSCCH has been (previously) detected on the SC, including any PSSCH that was not yet decoded. If such a PSSCH is detected then, in step 510, it may be determined that a collision has occurred (CCL=100%), and the process continues as at step 306 of process 300. If a non-decoded PSSCH is detected then, in step 514, an attempt is made to decode the PSSCH. If the PSSCH is successfully decoded then, in step 516, it is determined that there is no collision. If the PSSCH is not decoded then, in step 518, it is determined whether a PSCCH was previously decoded on the currently used SC, and if so then it may be determined that a collision has occurred (CCL=100%), and the process continues as at step 306 of process 300. If a PSCCH was previously decoded, then, in step 520, it may be determined whether the RSSI of the un-decoded PSSCH is above a threshold and if so then it may be determined that a collision has occurred, and the process continues as at step 306 of process 300. In such a case the CCL will be proportional to the RSSI such that the higher the RSSI, the higher the CCL.

The various features and steps discussed above, as well as other known equivalents for each such feature or step, can be mixed and matched by one of ordinary skill in this art to perform methods in accordance with principles described herein. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific disclosures of embodiments herein.

Unless otherwise stated, the use of the expression “and/or” between the last two members of a list of options for selection indicates that a selection of one or more of the listed options is appropriate and may be made.

It should be understood that where the claims or specification refer to “a” or “an” element, such reference is not to be construed as there being only one of that element.

It is appreciated that certain features of the invention, which are, for clarity, described in the context of separate embodiments or example, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments unless the embodiment is inoperative without those elements.

Citation or identification of any reference in this application shall not be construed as an admission that such reference is available as prior art to the present application.

What is claimed is:

1. A method comprising:
a) by a first vehicle-to-everything (V2X) transceiver and a second V2X transceiver operating in a V2X environment, transmitting using a first resource;
b) by a third V2X transceiver, detecting of a collision on the first resource caused by the transmissions of the first and second V2X transceivers;
c) by the third V2X transceiver, transmitting of a collision advertisement (CA); and
d) by one of the first and second V2X transceivers, reselecting a resource based on the CA.

2. The method of claim 1, wherein the collision detection may be performed by one or more of: decoding a physical sidelink control channel (PSCCH) on a subchannel (SC) that is known to carry a physical sidelink shared channel (PSSCH), attempting and failing to decode a PSSCH on an SC that is known to carry a PSCCH, and/or failing to decode both a PSCCH and a PSSCH on a SC with a high received signal strength indicator (RSSI).

3. The method of claim 1, wherein the CA is transmitted as part of a V2X transmission from the third V2X transceiver.

4. The method of claim 1, wherein the CA is inserted into the padding of a V2X packet.

5. The method of claim 1, wherein the CA is transmitted in a dedicated packet.

6. The method of claim 1, wherein the CA comprises CA parameters including one or more of: a collision confidence level (CCL), an indication of the resource on which a collision was detected, an RSSI measured on the resource, and/or a priority of a decoded PSCCH.

7. The method of claim 6, wherein the CA is identified by at least one of the first and second V2X transceivers based on an identifier prefix in the CA parameters.

8. The method of claim 6, further comprising, determining by at least one of the first and second V2X transceivers that the indicated resource is the same as the first resource used by at least one of the first and second V2X transceivers.

9. The method of claim 6, wherein the resource reselection is based on one or more of: the received CA parameters, a transmission process that used the resource, an allocation type used, a Channel Busy Ratio (CBR), and/or a priority of transmission.

10. The method of claim 1, wherein a time to collision resolution (TTCR) is between 50 ms and 200 ms.

11. A system comprising: a first vehicle-to-everything (V2X) transceiver operating in a V2X environment configured for detecting a collision caused by transmissions from at least a second and third V2X transceiver using the same first resource, wherein the first V2X transceiver is further configured for transmitting of a collision advertisement (CA) describing the detected collision.

12. The system of claim 11, wherein the at least second and third V2X transceivers are configured for decoding the CA and for determining whether to perform reselection of a resource based on the CA.

13. The system of claim 11, wherein the collision detection may be performed by one or more of: decoding a physical sidelink control channel (PSCCH) on a subchannel (SC) that is known to carry a physical sidelink shared channel (PSSCH), attempting and failing to decode PSSCH on an SC that is known to carry PSCCH, failing to decode both PSCCH and PSSCH on a SC with a high received signal strength indicator (RSSI).

14. The system of claim 11, wherein the CA is transmitted as part of a V2X transmission from the first V2X transceiver.

15. The system of claim 14, wherein the CA is inserted into the padding of a V2X packet.

16. The system of claim 14, wherein the CA is transmitted in a dedicated packet.

17. The system of claim 12, wherein the CA includes CA parameters including one or more of: a collision confidence level (CCL), an indication of the resource on which a collision was detected, an RSSI measured on the resource, and/or a priority of a decoded PSCCH.

18. The system of claim 17, wherein the CA is identified by the at least second and third V2X transceivers based on an identifier prefix in the CA parameters.

19. The system of claim 17, wherein the at least second and third V2X transceivers are configured for determining that the indicated resource is the same as the first resource used by the at least second and third V2X transceivers.

20. The system of claim 19, wherein the resource reselection is based on one or more of: the received CA parameters, a transmission process that used the resource, an allocation type used, a Channel Busy Ratio (CBR), and/or a priority of transmission.

21. The system of claim 11, configured such that a time to collision resolution (TTCR) is between 50 ms and 200 ms.
